(19) United States
(12) Patent Application Publication
(10) Pub. No.: US 2007/0036291 A1
(43) Pub. Date: Feb. 15, 2007

(54) Technique for voice email messaging in providing an information assistance service

(76) Inventor: Andrew P. Graham, Beaverton, OR (US)

Correspondence Address: BRANDON N. SKLAR;c/o Kaye Scholer LLP, 425 Park Avenue, New York, NY, 10022, US

(21) Appl. No.: 11/191,763

(22) Filed: Jul. 28, 2005

(51) Int. Cl. H04M 11/00

(52) U.S. Cl. 379/88.13

(57) ABSTRACT

Telephone users desiring directory assistance services are connected via standard telephone procedures to a directory assistance provider, such as an operator. An operator obtains the destination telephone number and initiates a connection to that number. Once that connection is initiated, the connection is monitored for the occurrence of a predetermined condition, such as a busy signal. If no such condition is detected, the caller proceeds with the call in the normal manner. If, however, such a condition is detected, the caller may be offered an option to send a voice email to the destination party.

### FIELD OF THE INVENTION

The invention relates to a communications system and method, and more particularly to a system and method for providing an information assistance service facilitating a user's communications with a desired party through the service.

### BACKGROUND OF THE INVENTION

It is a common experience to use a wireline or wireless telephone to call an operator for information assistance. In a typical information assistance call, a caller identifies to the operator the name and address (sometimes city or area code) of a party whose telephone number is desired. In response, the operator locates the desired destination number using a computer database, for example. The destination number is then provided to the caller. The number may be provided by a voice server which provides automated voicing of the number. The caller may be afforded an option to be connected to the destination number without the need of first terminating the information assistance call.

With the advent of voice messaging, also known as “voicemail,” a person who knows someone else's telephone number is able to make a phone call to that other person and leave him or her a recorded message. With e-mail, a person who knows someone else's e-mail address is able to send an electronic message to that other person.

Recently, a service called Trekmail (www.trekmail.com) has been developed in which a person who knows someone else's e-mail address is able to send an e-mail containing a voice message, also known as a “voice email,” to that other person using the e-mail system. The caller sets up a profile with Trekmail, including the caller's name, an account number (user ID), a password or personal identification number (PIN), and a “signature” with which to sign the message. In order to use the service, the caller calls a central Trekmail telephone number (or voice message server) and identifies him- or herself using the account number and password. The Trekmail server, using an interactive voice response (IVR) unit, requests from the caller the e-mail address of the person (the recipient) to whom the caller would like to send a message. The caller then records the message using the telephone, the Trekmail server converts the message to a sound file, attaches the sound file to the e-mail message and sends the e-mail message to the recipient. The e-mail message appears in the recipient's e-mailbox with the caller's return e-mail address and the caller's “signature.” In order to hear the message, the recipient opens the e-mail message and the attached sound file.

### Summary of the Invention

The problem with the Trekmail-type messaging system is the difficulty that the IVR has in recognizing the recipient's e-mail address. E-mail addresses come in many forms, and there are many different ways of verbalizing the addresses. For instance, the typical e-mail address “smith@business.com” includes the recipient's name (“smith”), followed by an “at” sign (“@”), followed by the domain name (“business”), a period, and an extension (“.com”). The sender likely pronounces the address, “smith at business dot com”, and the IVR may be able to recognize it. However, many e-mail addresses differ from this typical address. The recipient's name may include a first initial, e.g., “jsmith,” or a first name, e.g., “jaysmith,” or may include other punctuation to set off the first name from the last name, e.g., “j.smith” “jay.smith,” or “j_smith.” When the caller speaks this part of the e-mail address, the IVR cannot distinguish between “jsmith” and “jaysmith,” or “j dot smith” and “jay dot smith.” The IVR may also encounter confusion if some callers say “jay dot smith” and others say “jay period smith.” Similarly confusing words can occur with the domain name, especially since many e-mail addresses have more than one extension, e.g., @business.co.au. The IVR may also have trouble interpreting the words that the speakers say, either because the speakers do not speak clearly or because of the accent or speed with which the address is spoken. Some people may speak the e-mail address using words, and others may spell the whole address out, and others may combine the two methods. In addition, because many parts of e-mail addresses are names and may actually be two or more words concatenated into one, it is difficult to match words using a standard dictionary.

The invention is directed to providing an information assistance service, which offers a voice email messaging option to a caller on a conditional basis, with an object to avoid the above-identified problem with the caller's utterance of an email address during the call. In accordance with the invention, when a call is received from a caller, which includes an information assistance request, a database is searched for a destination telephone number associated with a destination party in response to the request. A connection is established for connecting the call to a communication device associated with the destination telephone number. A condition of the connection (e.g., busy, ring-no-answer, etc.) is then monitored. When one such condition is detected, a second database is automatically searched for a record associated with the caller based on caller identifying information (e.g., an automatic number identification (ANI)) communicated to the service during the call. The record is then searched for data concerning an email address associated with the destination party based on the destination telephone number. Such a record may be a private directory maintained by the information assistance service for the caller to keep contacts information. If the email address of the destination party is found in the record, the caller is offered with an option to send an email message to the email address. Because the email address was previously entered into the record, e.g., by the caller through a data connection, the need of the caller's utterance of the email address during the call is advantageously avoided.

### BRIEF DESCRIPTION OF THE DRAWINGS

These and other features, aspects, and advantages of the present invention will become more readily apparent from the following detailed description, which should be read in conjunction with the accompanying drawings, in which:

FIG. 1 illustrates a communications system including information/call centers, in accordance with the invention;

FIG. 2 illustrates the components of an information/call center in the system of FIG. 1;

FIG. 3 provides a detailed view of a telephone switch used in an embodiment of the invention;

FIG. 4 provides a detailed view of a voice server used in an embodiment of the invention;

FIGS. 5A and 5B jointly depict a process for providing a voice email messaging service in accordance with the invention; and

FIG. 6 illustrates a contacts record maintained for a user, in accordance with the invention.

### DETAILED DESCRIPTION

The present invention is directed to providing a voice email messaging service in case an attempt by an information assistance service provider to connect a user to a destination telephone number fails. For example, when the connection to the destination party encounters a busy signal, ring-no-answer, network communication problem, or other non-completion signal, the information assistance call may be automatically reconnected to the information assistance service provider, as disclosed in U.S. Pat. No. 6,456,709, incorporated herein by reference. The provider may then offer to the user an option to send a voice email to the destination party containing a voice message by the user. To minimize the above-identified confusion associated with verbally conveying an email address, e.g., to a voice server to address the voice email, the information assistance service provider may maintain one or more contacts folders (also known as private directories) associated with the user. In accordance with the invention, an email address of the destination party may be located from one such contacts folder based on the destination party's name and/or the destination telephone number, thereby obviating the user's need of verbally conveying such an email address to a voice server.

As disclosed in U.S. Pat. No. 6,870,921, incorporated herein by reference, a user may have multiple contacts folders for different purposes, such as a personal contacts folder, business contacts folder, sports team contacts folder, etc. Other folders may include events, products, and other information that may be tailored to the needs of an individual or a group, e.g., a corporation, an organization, or a collection of people having a common interest. These folders may be identified by the user's telephone number (or automatic number identification (ANI)). The user may create, maintain, or access a contacts folder (containing, e.g., names, phone numbers, email addresses, etc. of the respective contacts) via the Internet or other communications means, or through an operator who in turn may create, maintain, or access the folder on behalf of the user.

As is well known, the ANI identifies the telephone number of the communications device from which the call originates. However, it should be noted that a user identification (ID), password, PIN, mother's maiden name, user voiceprint, etc. may be used in combination with, or in lieu of, an ANI to identify a user or his/her contacts folders. For example, use of a voiceprint to identify a user is disclosed in copending, commonly assigned U.S. Application Ser. No. 10/403,207 filed on Mar. 31, 2003, incorporated herein by reference.

In one embodiment, when a call is received from a user, which includes an information assistance request, an information assistance service provider conducts a search on a database in response to the request. The search result, e.g., a destination number, is stored in association with the call. An attempt is made to connect the user to a communications device associated with the desired destination party, and may be reconnected to the information assistance service provider when the attempt is unsuccessful. In that case, the destination number and ANI associated with the call are retrieved. Using the ANI, the information assistance service provider locates any contacts folders associated with the user. Using the destination number, the provider searches any such contacts folders for a directory record associated with the destination party. If any such directory record is found, the record is then searched for an-email address of the destination party therein. If any such email address is found, the user may be afforded an option to send a voice email to the destination party utilizing the email address.

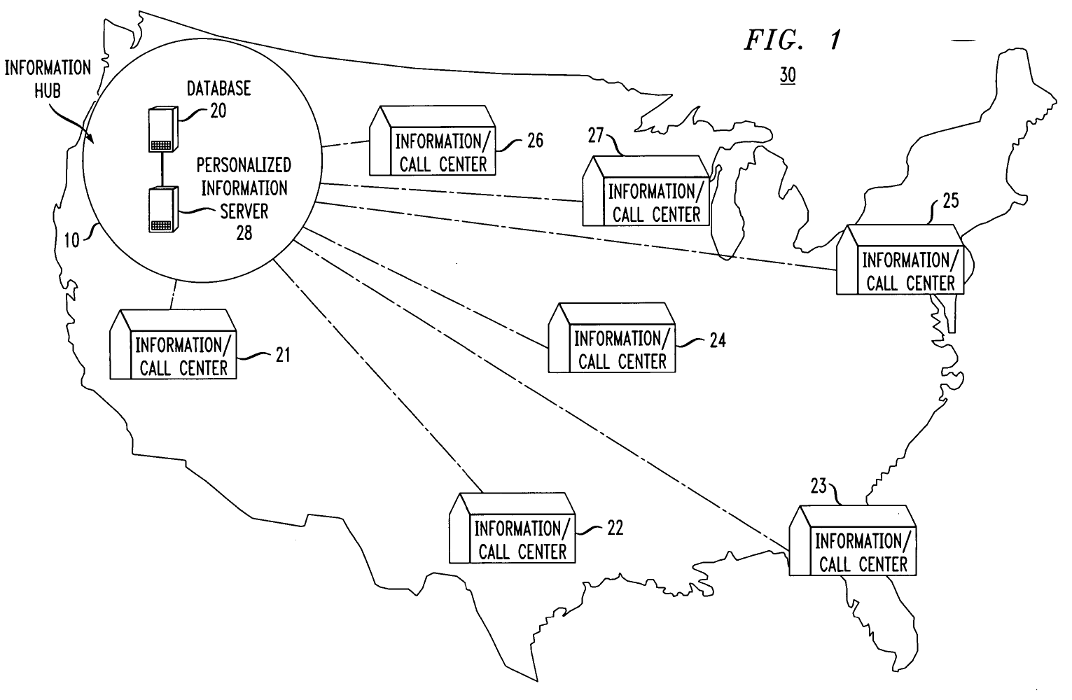

FIG. 1 illustrates a communications system for providing, inter alia, a voice email messaging service in accordance with the invention. This communication system includes wide area network (WAN) 30 covering an extensive area. WAN 30 may be an Internet-based network such as the World Wide Web or a private intranet based network. WAN 30 connects operators dispersed throughout a wide coverage area in information/call centers 21 through 27. It should be noted that the term “operators” used herein broadly encompasses entities that are capable of providing assistance in a telecommunications environment, including without limitation human operators, voice response/recognition capabilities, web-/WAP-enabled operator services, and other automated and electronic access. One or more information hubs 10 are also included in WAN 30. An information hub 10 includes one or more personalized information servers 28 which are accessible to components of information/call centers 21 through 27, and one or more databases 20 in which users'contacts and other folders may be stored and maintained. Such folders may also be stored locally at one or more of the information/call centers. The folders and information at different centers are synchronized. Synchronized databases provide necessary backup as well as support to roaming mobile device users.

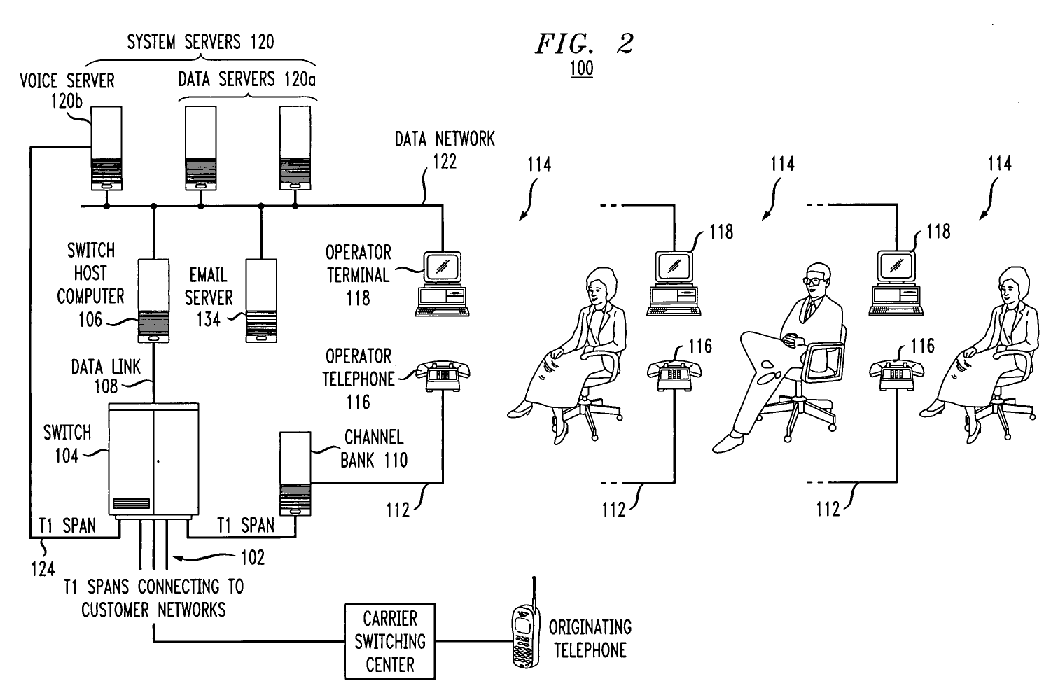

With reference to FIG. 2, an information/call center 100 according to an exemplary embodiment of the invention is depicted. One or more T1 external communication links 102 connect information/call center 100 to customers and customer telephone networks. Communication links 102 connect to telephone switch 104, which is connected to switch host computer 106 via switch data link 108. In an alternative embodiment, switch host computer 106 is coterminous with telephone switch 104.

Telephone switch 104 is attached via a T1 communication link to channel bank 110, and from there connects to operator channel 112 and a plurality of operator telephones 116. Operator telephones are located at each of one or more operator positions (represented by the numeral 114 in FIG. 2), Using operator data terminal 118, a live operator at operator position 114 accesses one or more system servers 120, which are interconnected via data network 122. Email server 134 and switch host computer 106 are also connected to data network 122. Email server 134 is used to compose voice email, format the voice email in a standard protocol, and transmit the same via the Internet. Finally, switch 104 is connected to one or more voice servers, which are described below. Each connection to a voice server employs a T1 voice server link (a first voice server link 124 is shown in FIG. 2).

In one embodiment, the voice server 120b, data server 120a, and switch host computer 106 have redundant systems (not shown), which can operate as either back-up systems in the event of primary system failure, or provide load-sharing in either a master-slave or a peer-to-peer relationship with the primary system.

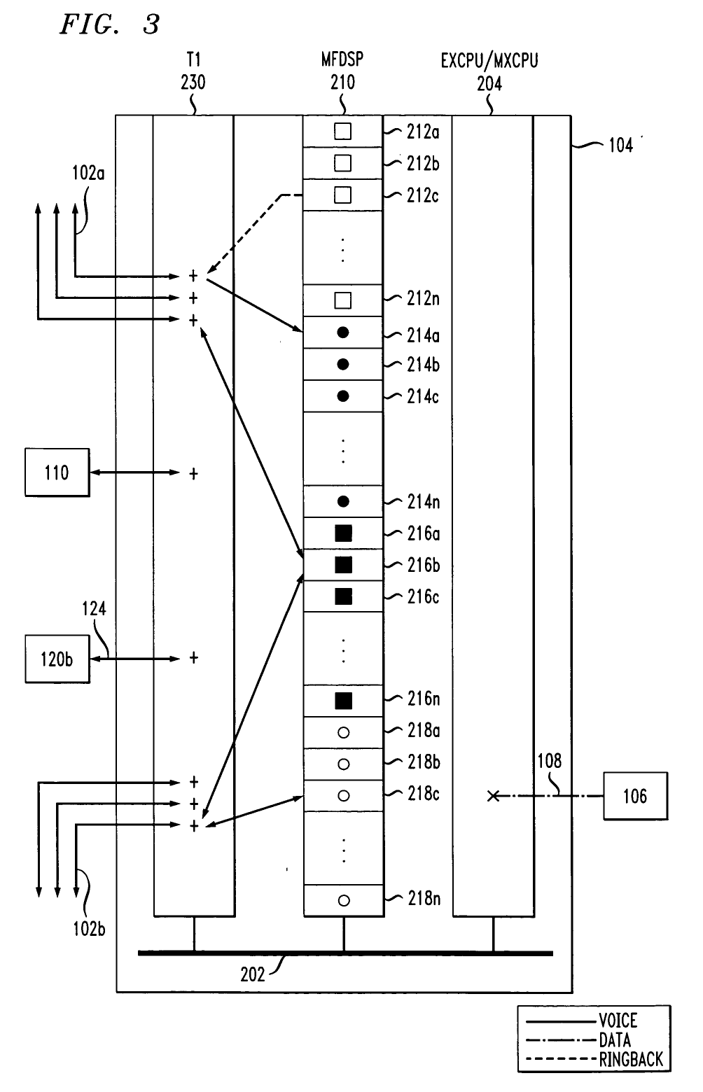

As stated above, communication links 102 provide telephone connections to information/call center 100 for incoming information assistance calls and also provide access to external telephone networks over which outgoing calls are placed. An incoming call is received via inbound channel 102a (shown in FIG. 3) and an outgoing call is placed over outbound channel 102b (shown in FIG. 3). There is generally one outbound channel 102b for every inbound channel 102a, so that for every call into directory assistance system 100 there is an outbound channel available to reach the caller's desired party or parties. Communication links 102 may, in an illustrative embodiment, be comprised of one or more T1 communication spans which are known in the art. In such an embodiment, each individual call over a T1 span, whether into or out of telephone switch 104, utilizes one of the 24 individual channels into which a T1 span is segmented, each channel providing two-way communications.

Telephone switch 104 is now described in further detail with reference to FIG. 3. Operation of telephone switch 104 is governed by computer-readable instructions stored and executed on switch host computer 106. In one embodiment of the invention, telephone switch 104 is an Excel LNX 2000 and switch data link 108 is a 38.4 kb serial link; in another embodiment, switch data link 108 is an Ethernet link.

Telephone switch 104 includes expandable central processing unit (“EXCPU”) 204 and/or matrix central processing unit (“MXCPU”) 204. EXCPU/MXCPU 204 serves as an interface for telephone switch 104 to switch host computer 106 (via switch data link 108).

EXCPU/MXCPU 204 and other components of telephone switch 104 communicate through shared communication path 202, commonly called a “midplane.” In the currently-described embodiment, midplane 202 utilizes a time division multiplexing (“TDM”) method of sharing a common pathway. Thus, a plurality of data and/or voice streams can be interlaced onto the single path, separated by time.

Another board-level component of telephone switch 104 is multi-frequency digital signal processor (“MFDSP”) unit 210, which includes four single in-line memory module (“SIMM”) packagings. Each SIMM packaging is comprised of four DSP. arrays. Each DSP array is composed of multiple, illustratively sixteen, programmable DSPs. The DSPs can be programmed or reprogrammed to function as, among other things, call progress analyzers (“CPA”), call progress generators (“CPG”), multi-frequency (“MF”) receivers or transmitters, dual-tone multi-frequency (“DTMF”) receivers or transmitters, or conference units, depending upon the demand placed on directory assistance system 100 and telephone switch 104 for each corresponding function.

CPAs (represented by the numeral 218 in FIG. 3) are sensitive to, and capable of identifying, telephone connection status conditions and signals including ring tone, busy, reorder, PBX intercept, SIT intercept, vacant code, reorder-SIT SIT, no circuit LEC, reorder-carrier, no circuit-carrier, dial tone, continuous on tone, and silence. In an exemplary embodiment of the invention, one CPA will monitor only one outbound channel 102b at a time. In other embodiments of the invention, one CPA may be applied to more than one outbound channel. However, to ensure that connection status conditions are properly detected, the number of outbound channels monitored by one CPA should be kept to a minimum (i.e., no more than four). In still other embodiments of the invention, two or more DSPs may be applied to a single outbound channel.

CPGs (represented by the numeral 212 in FIG. 3) generate tones to customers connected to directory assistance system 100, such as the ringback tone customers hear when they are routed to an operator.

DTMF receivers (represented by the numeral 214 in FIG. 3) listen for DTMF tones generated by customers' telephones, such as when a customer presses a telephone button. DTMF receivers are capable of detecting and identifying which button was pressed (i.e., the numbers 0-9 or the characters “*” or “#”) and passing that information to switch host computer 106 for appropriate action. DTMF receivers are assigned to monitor inbound channels for a configurable period of time, illustratively, from the time of a caller's initial connection to telephone switch 104 to the time the caller disconnects, including the duration of all outbound call legs made on the caller's behalf. Once applied to an inbound channel, a DTMF receiver allows telephone switch 104 to detect the press of a telephone button, perhaps done in order to activate tone-triggered return transfer as described in U.S. Pat. No. 5,737,700, which is incorporated herein by reference, or another feature of directory assistance system 100.

Conference units (represented by the numeral 216 in FIG. 3) enable telephone switch 104 to connect two or more voice paths in a balanced manner, thereby providing the necessary voice connections between calling parties, called parties, and directory assistance providers.

In the presently-described embodiment, each DSP array provides multiple instances of the function for which it is programmed, the exact number depending upon the specific function. For example, each DSP array programmed to provide CPA, CPG, or DTMF receiver functions provides sixteen instances of the chosen function. In other words, a DSP array programmed to provide call progress analyzer functions will contain sixteen separately and independently functional and controllable CPAs. A DSP array programmed to provide conference unit functions, however, provides only four instances of such function. The programmable DSPs on MFDSP unit 210 are managed by switch host computer 106 via EXCPU/MXCPU 204, which keeps track of which DSPs are available and which are allocated.

An additional board-level component of telephone switch 104 is T1 interface unit 230. Switch 104 contains one or more T1 interface units; each unit provides connections to eight T1 (1.544 Mb/sec) spans, each of which is comprised of 24 channels, thus providing 192 64 kb voice channels per T1 interface unit. In FIG. 3, T1 interface 230 dedicates twelve channels on each of six of the eight spans to incoming calls and the other twelve to outgoing calls. The seventh T1 span serves as voice server link 124, and the eighth functions as a link to channel bank 110 and operator channel 112. Voice server link 124 and operator channel 112 are used to connect directory assistance callers to a voice server or a live operator, respectively.

It will be recognized by one skilled in the art that multiple instances of telephone switch 104 may be incorporated into a telephone network or directory assistance system 100 without exceeding the scope of this invention.

In the preferred embodiment, switch 104 supports digital T1 telephone circuits and includes digital signal processing circuitry which provides the requisite conference capability, SS7 message generation/detection capabilities, and dual tone multi-frequency (DTMF) and multi-frequency (MF) tone generation/detection capabilities. With respect to the SS7 functionality, switch 104 acts as a signaling node, also known as a service switching point.

Switch host computer 106 stores and executes computer-readable instructions for purposes of, among others, configuring and operating telephone switch 104 and directing the transfer of calls through switch 104. It also directs the playback of recorded messages to callers connected to directory assistance system 100. Pre-recorded greeting and closing messages played for callers are recorded in the voice of the operator to whom the caller will be, or was, connected. Switch host computer 106 directs the playback of the appropriate message by identifying the operator and the inbound channel 102a the caller is connected to and specifying the message to be played.

Further, switch host computer 106 maintains call data for each information assistance call connected to directory assistance system 100. The call data stored on the host computer consists of the most recent assistance request received from each caller, and includes one or more of: the calling telephone number (i.e., ANI), the date and time of the caller's connection to information/call center 100, the T1 span and channel the caller is connected to, the caller's desired destination telephone number, the status of the caller's previous directory assistance request, which operator assisted the caller, etc. Additional call data is stored on system servers 120, as described below. For example, the call data stored on switch host computer 106 and system servers 120 are provided to information assistance providers when a caller makes multiple information assistance requests in one call to information/call center 100. By considering the collected call data, such as the. information that was provided to a caller in a previous request, an information assistance provider can tailor subsequent assistance to be more effective.

In one embodiment, the call data associated with a user's information assistance call and, in particular, the ANI and the destination telephone number to which the caller is connected, which connection however cannot be completed, are used to look up any email address associated with the destination party in a user's contacts folder to send a voice email to the destination party, in accordance with the invention.

Switch host computer 106 also directs the transfer of information between itself and system servers 120 (via data network 122) as well as between system servers 120 and switch 104 and operator position 114 (via channel bank 110 and operator channel 112).

Operator position 114 includes means by which a live operator receives calls, determines caller's informational needs, searches for and retrieves information from system servers 120, provides information to callers, and initiates outgoing calls. In an exemplary embodiment of the invention, an operator at operator position 114 is provided with a telephone headset 116 for interacting with callers, and data terminal 118, connected to data network 122, for interacting with system servers 120.

Each operator is equipped with a terminal 118 that includes a monitor and keyboard with associated dialing pad. The operator terminals are coupled over a data network 122 to a data server 120a, allowing an operator to access the data in data server 120a through the operator terminals 118 and fulfillment agent terminals 121.

System servers 120, which are interconnected via data network 122, include one or more data servers 120a which provide and manage data services within information/call center 100. Data servers 120a maintain databases containing telephone and business directories, billing information, and other information in computer-readable form to be searched, e.g., in response to callers'requests. As introduced above, data servers 120a also store call data for later retrieval by information assistance providers furnishing subsequent assistance to a caller. The call data stored on data servers 120a illustratively include how and where a directory assistance provider searched for information to satisfy a customer request, the information retrieved by the assistance provider, how that information was displayed for the assistance provider, and the form in which it was communicated to the caller. Unlike switch host computer 106, data servers 120a save call data concerning all requests made by a caller during one call to information/call center 100, not just the most recent request.

Billing information is stored in the form of call records, which are created for each customer call into information/call center 100. They contain data such as the caller's telephone number, the date and time of the caller's connection to information/call center 100, the dates and times of attempted connections to destination parties, the duration of each call leg, etc. One or more call records are created for recording events occurring during an information assistance call, and are closed when the customer disconnects from the information/call center 100.

The software used to create and manipulate the databases on data servers 120a is known in the art of computer software and allows information assistance providers to search the databases by name, address, type of goods or services, geographical region, etc. In FIG. 2, switch host computer 106 and data servers 120a are depicted as distinct entities; in an alternative embodiment they are coterminous.

System servers 120 also include one or more voice servers (a first voice server 120b is shown in FIG. 2) that provide, in alternative embodiments of the invention, all or a subset of the operator functions provided by a live operator at operator position 114. For example, voice servers store and deliver messages that live operators would otherwise be required to frequently repeat for callers, such as greetings, closing messages, and the caller's requested telephone number.

The voice server 120b, also called a voice response unit (VRU), is incorporated into the system to play the frequently repeated parts of an operator's speech, namely the various greetings and signoffs (or closings), and the caller's desired telephone number where requested. Not only does this system provide a voice-saving and monotony-relief function for the operators, it performs a “branding” function (i.e. the pre-recorded messages incorporate the name of the telephone company through which the caller was routed to the directory assistance service), and it also reduces the amount of time an operator is actually connected to a caller. The voice server may also contain a voice recognition system for receiving verbal input from a party connected to the voice server.

In the preferred embodiment, the databases accessible to servers 120a provide the capability to search not just by name and address, but also by type of goods/services and/or geographical region, or by any other attribute in the caller record, including phone number. For example, the preferred database can answer queries soliciting the names/numbers of Chinese restaurants on a given street. Data indexed in this fashion is usually not commercially available, so the present assignee starts with a commercially available database file (e.g. the Directory Assistance Database Source available from U.S. West), and enriches it by adding further data manually. The databases may be SQL relational databases. SQL (Structured Query Language) is a standard interactive and programming language for getting information from and updating a database. Queries take the form of a command language that lets you select, insert, update, find out the location of data, and so forth.

Desirably, the results of the database search presented on the operator's terminal 118 are not alphabetized prior to display, but rather are presented in the order located by the database search engine. (If desired, a deliberate randomization of order could be effected before display.) Businesses at the beginning of the alphabet are thereby not unduly favored by callers using the directory assistance service. In the alternative, businesses can bid to be listed at the beginning of the list.

The database software itself is conventional. The presently preferred best mode is to use a relational database, such as is available from Sybase. However, much simpler software can alternatively be used, such as DBase 4.

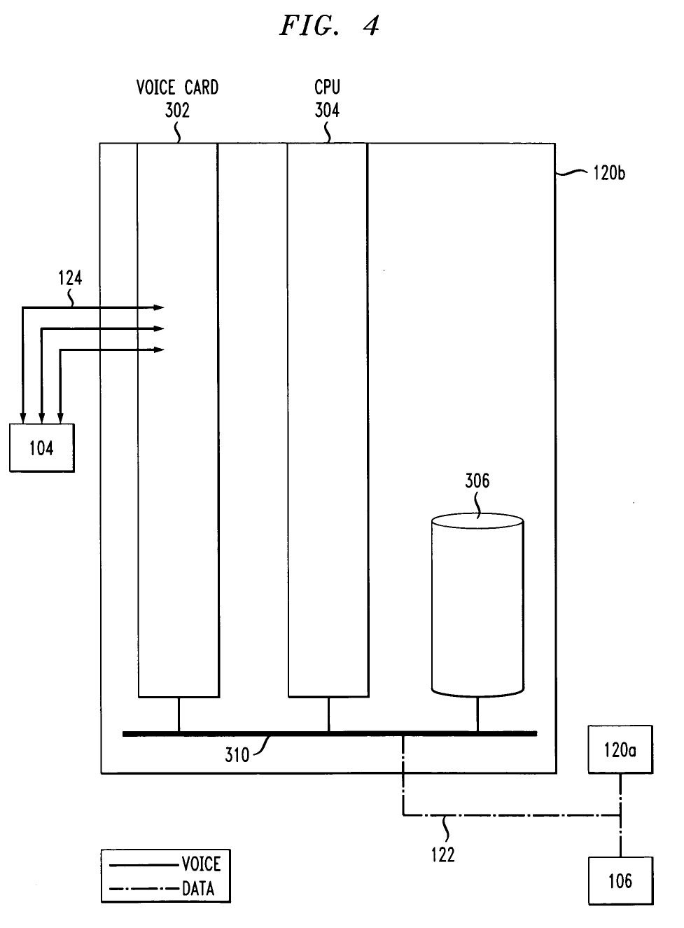

In an illustrative embodiment, depicted in FIG. 4, voice server 120b is connected to telephone switch 104 by voice server link 124 and to switch host computer 106 and data servers 120a via data network 122. Each voice server connects to telephone switch 104 via a separate voice server link. Voice server 120b consists of a general purpose computer plus one or more voice cards (a first voice card 302 is depicted in FIG. 4), which serve as the interface between voice server link 124 and voice server 120b. Voice card 302 monitors and controls communications over voice server link 124; its capabilities include telephone tone detection and generation, voice recording and playback, and call progress analysis. Therefore, very similar to telephone switch 104, voice server 120b is capable of detecting connection status conditions, detecting customer keypresses, and generating tones. Although FIG. 2 depicts voice server 120b distinct from data servers 120a, in alternative embodiments they are coterminous.

Voice server 120b also includes typical computer components such as central processing unit 304, data storage unit 306, and bus 310 for transferring voice and data signals. Voice server 120b may also contain a voice recognition subsystem (not shown) for receiving verbal input from a party connected to the voice server.

Voice server link 124 provides voice connections between telephone switch 104 and voice server 120b, thus providing means by which callers may be connected to voice server 120b and receive automated operator assistance. Voice server link 124, in an illustrative embodiment of the invention, is comprised of one or more T1 spans, with each one of the 24 channels of each span providing two-way communication.

At appropriate stages in a call progression, the switch host computer 106 initiates a voice path between the voice server and the switch 104 such that the caller, or the caller and the operator, are able to hear whatever pre-recorded speech is played on that circuit by the voice server. Computer 106 then instructs the voice server, via the data network, what type of message to play, passing data parameters that enable the voice server to locate the message appropriate to the call state, the service-providing telephone company, and the operator. The recording density used is high enough to provide a good enough quality of message playback that most users of the system should be unaware they are listening to a recording.

When, as described below in connection with one method of implementing this invention, the caller is connected to voice server 120b after a busy signal or a ring-no-answer condition is detected, subsequent monitoring of inbound channel 102a and outbound channel 102b is performed by voice server 120b; switch 104 continues to monitor outbound channel 102b to detect, for example, when the destination telephone is answered or disconnected. As mentioned above, voice server 120b contains voice card 302 which provides telephone signal detection and generation capabilities comparable to those of telephone switch 104. By drawing upon these capabilities, information/call center 100 can offer the voice email messaging service in accordance with the invention and other advanced information assistance services to callers.

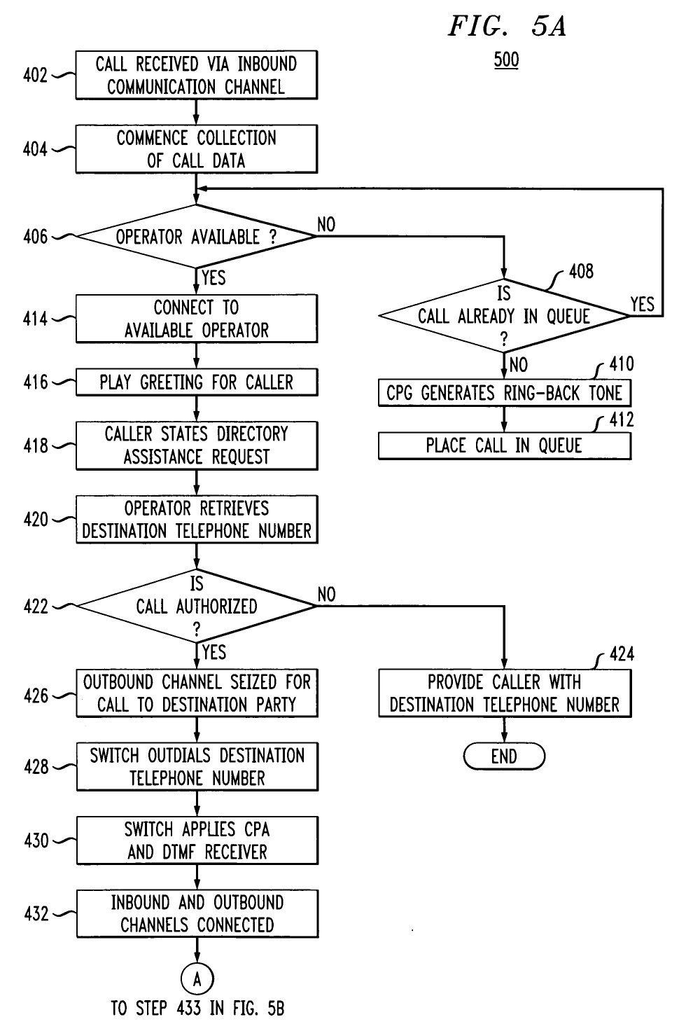

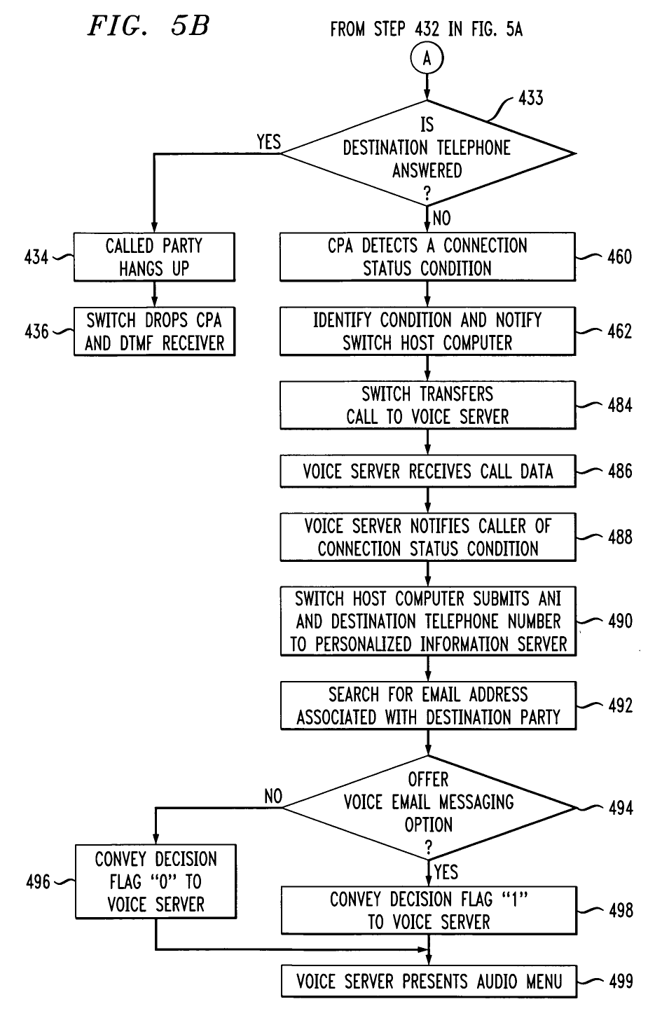

FIGS. 5A and 5B jointly illustrate a process 500 in accordance with the invention wherein the voice email messaging service is made available to a caller who cannot successfully reach a destination party through the information assistance service. Switch host computer 106 is programmed to run process 500.

An information assistance call is received (step 402) by at T1 interface 230 of telephone switch 104 via inbound communication channel 102a. The information assistance call may originate at virtually any telephone, whether wireless, portable, or stationary. Callers of a particular telephone company simply dial the access digits established for directory assistance by that company. Examples of typical access digits are “411” “*555” “555-1212” “1-800-555-1212” “00,” or other designated access numbers. The participating telephone company's own switching system will then reroute the call to, say, information/call center 100 (via a T1 channel), where it appears as an incoming call.

In receiving the call, switch 104 also receives data concerning the caller's identity, such as the caller's ANI, and the area of the call's origination, such as the originating cell site. Switch host computer 106 and data server 120a commence (step 404) the collection of call data, starting with the information listed immediately above. The call data is updated as information/call center 100 takes action on behalf of the caller. Therefore, when a caller makes successive assistance requests, the directory assistance provider (i.e., a live operator or voice server 120b) called upon to satisfy each subsequent request can refer to information concerning the caller's connection to directory assistance system 100 and the information provided in response to the caller's previous requests.

Switch host computer 106 determines (step 406) whether any directory assistance operators are available. If no operators are immediately available, and the caller has not already been waiting (step 408) for an operator, CPG 212 generates (step 410) a ringback tone across T1 interface 230 to inform the calling customer that his or her call is being queued to await an available operator. Waiting calls are then placed (step 412) into an automatic call distribution queue (“ACDQ”) which is maintained by switch host computer 106 and constructed such that queued calls are routed to available operators in the order in which they were received. When one or more operators are available (step 406), a. queued call, or if no calls are queued then a new call, is connected (step 414) to an available operator by switch 104 through EXCPU/MXCPU 204 and operator channel 112.

Once connected to an operator, a greeting message is played (step 416) for the caller. In illustrative embodiments, the message may be live from an operator or recorded (in the voice of the operator to whom the call is connected) and played back by voice server 120b. Switch host computer 106 directs the playback of recorded messages from voice server 120b by identifying the inbound channel 102a and the operator with which the caller is connected and specifying the message that voice server 120b is to play.

The caller typically then states (step 418) his or her directory assistance request by identifying, as far as he or she is able, the destination party he or she wishes to contact. The operator searches databases of information stored on data servers 120a, for the appropriate destination telephone number. Database records matching the caller's query may be displayed on the inquiring operator's data terminal 118 in a variety of formats, such as alphabetical, random, etc. The operator retrieves (step 420) the information most closely matching the caller's request.

Based on the destination telephone number retrieved by the operator, the caller identification information received with the call by directory assistance system 100, and call authorization data stored on data servers 120a, the operating software on the data servers attempts to verify (step 422) the caller's authorization to connect to the destination telephone number through directory assistance system 100. For example, a caller may not be authorized to make long-distance telephone calls on his or her account. When such a caller connects to information/call center 100 from his or her home local calling area, the software simply determines whether the caller is trying to call a destination telephone number outside of the caller's local calling area. If, however, the caller is connected to information/call center 100 from a calling area outside of his or her home local calling area, the software uses the ANI received with the call, as well as the destination telephone number, to determine whether the caller is attempting to place a long-distance call.

If the caller is not authorized (step 422) to make the requested call through information/call center 100, the caller will merely be provided with the destination telephone number (step 424). If, however, authorization is verified (step 422), the operator initiates an outgoing call for the caller by seizing (step 426) outgoing communication channel 102b from T1 interface 230 and outdialing (step 428) the destination telephone number. Outdialing is a function of telephone switch 104, whereby switch 104 transmits the destination telephone number after it is entered. Entry of the destination telephone number may be done manually by an operator (i.e., the operator keys the number in via operator telephone 116) or automatically by data server 120a (i.e., data server 120a delivers the destination telephone number to switch 104 after the number is identified by the operator).

Switch host computer 106 is notified of the outgoing call and automatically instructs telephone switch 104 to apply (step 430) CPA 218 to outbound channel 102b and DTMF receiver 214 to inbound channel 102a after outdialing. Although a plurality of the programmable DSPs on MFDSP unit 210 are allocated and configured as CPAs and DTMF receivers, they remain in a quiescent state until assigned to an outbound channel. Telephone switch 104 then connects (step 432) the calling customer on inbound channel 102a to the outgoing call on outbound channel 102b.

CPA 218 monitors the outgoing call on outbound channel 102b for a predetermined number of rings, a predetermined amount of time, or until a specified connection status is detected. A successful call, in which the destination telephone is answered, is recognized by T1 interface 230 of switch 104. Illustratively, T1 interface 230 identifies a successful call by detecting, on outbound channel 102b, the bit transition that occurs when the destination telephone converts from an on-hook status to an off-hook status. The detection of a successful call is relayed to switch host computer 106 by switch 104. In one telephone switch according to the invention, T1 interface 230 first notifies EXCPU/MXCPU 204 of the successful call via TDM midplane 202. EXCPU/MXCPU 204 in turn notifies switch host computer 106 via switch data link 108.

When an outgoing call is successfully completed (step 433), directory assistance system 100 remains passively connected to the call. When the destination telephone is disconnected (step 434), T1 interface 230 detects another bit transition indicating that the destination telephone changed from off-hook to on-hook, and switch 104 drops (step 436) CPA 218 and DTMF receiver 214.

If, however, the call is unsuccessful (step 433), CPA 218 will detect (step 460) a telephone connection status condition such as a ring tone, busy, reorder, PBX intercept, SIT intercept, vacant code, reorder-SIT, no circuit LEC, reorder-carrier, no circuit-carrier, dial tone, continuous on tone, or silence. Telephone switch 104 identifies (step 462) the condition and notifies switch host computer 106.

If the detected condition is identified as a busy signal, telephone switch 104 drops CPA 218 and DTMF receiver 214 from outbound channel 102b and inbound channel 102a, respectively, then terminates the outgoing call by releasing outbound channel 102b. Switch 104 then transfers the caller to voice server 120b.

If a ring-no-answer condition is detected, it is desirable to allow sufficient time for the called party to answer the call, but yet also provide the caller with options other than simply waiting continuously for an answer. After telephone switch 104 drops CPA 218 and DTMF receiver 214, it bridges (or conferences) voice server 120b onto the caller's connection. The ring tone received over outbound channel 102b is muted.

Connection status conditions such as reorder, PBX intercept, SIT intercept, vacant code, reorder-SIT, no circuit LEC, reorder-carrier, no circuit-carrier, dial tone, continuous on tone, and silence indicate a communication problem in the telephone network. In the event that one of these conditions is identified, telephone switch 104 drops CPA 218 and DTMF receiver 214 and releases outbound channel 102b. Voice server 120b is connected to the caller.

After switch 104 transfers (step 484) the call to voice server 120b because of one of the above-described connection status condition, voice server 120b receives (step 486) the associated call data from switch host computer 106 and data servers 120a. Voice server 120b then notifies (step 488) the caller of the detected connection status condition. In the meantime, switch host computer 106 submits (step 490) the ANI and the destination telephone number associated with the call to personalized information server 28, and causes. (step 492) server 28 to search for an email address associated with the destination party, in accordance with the invention. To that end, upon request by computer 106, server 28 searches for any contacts folders associated with the caller stored in database 20 based on the received ANI. When any such contact folders are located, server 28 further searches the contacts folders for any contacts record associated with the destination party based on the destination number. When any such contacts record is located, server 28 further searches the contacts record for any email address associated with the destination party therein.

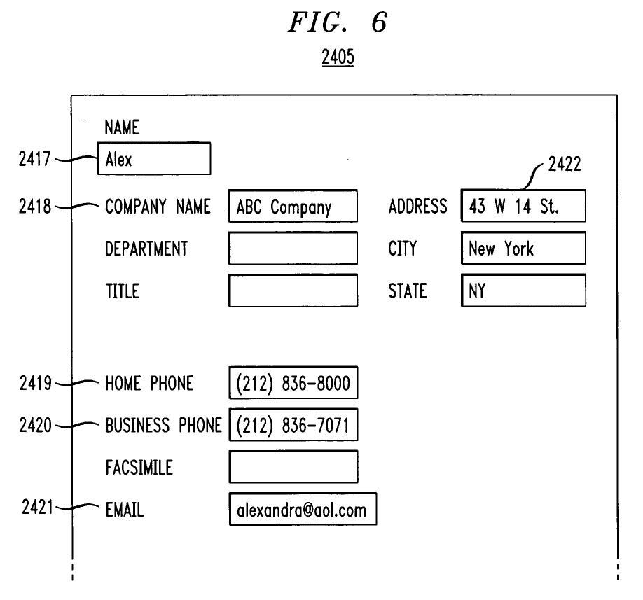

By way of example, let's say the information assistance service in this instance maintains for the user a contacts record of the destination party, say, “Alex.” FIG. 6 illustrates such a contacts record that may be maintained for the caller. Record 2405 includes information pertaining to the destination party Alex. Name field 2417 contains the name of the respective individual (in this instance, (“Alex”). The record includes fields for a variety of additional information pertaining to Alex. For example, fields 2418, 2419, 2420, 2421, and 2422 contain information pertaining to Alex's company name, home phone, business phone, email address, and address, respectively.

Server 28 notifies computer 106 of whether server 28 has successfully located the destination party's email address. Host computer 106 then determines (step 494) whether a voice email messaging option to be described should be offered to the caller based on the notification from server 28. If server 28 cannot locate the destination party's email address, host computer 106 would not offer the option. Accordingly, computer 106 conveys (step 496) a decision flag value “0” to voice server 120b, indicating thereto its decision not to offer a voice email messaging option. Otherwise, if server 28 manages to locate the destination party's email address, which is the case here, host computer 106 would offer one such option. Accordingly, computer 106 (step 498) conveys a decision flag value “1” to voice server 120b, and causes server 28 to provide the located destination party's email address, i.e., alexandra@aol.com in this instance, to email server 134 in anticipation of sending a voice email to the destination party at the caller's request. After server 120b receives the decision flag value, server 120b initiates DTMF detection on inbound channel 102a, using voice card 302, in order to detect keys pressed by the caller.

Voice server 120b presents (step 499) the caller with an audio menu of options which varies with the received decision flag value. The caller then chooses one of the options by pressing the specified key, illustratively, the “#” key to have voice server 120b recite the dialed telephone number, the “*” key to transfer the caller to a live operator, the “3” key to record a voicemail for later delivery to the destination number, the “7” key to receive the destination telephone number via the caller's alphanumeric pager or telephone. In addition, voice server 120b provides the aforementioned voice email messaging option, selectable by pressing “2” key, to send a voice email to the destination party since, in this instance, voice server 120b has received the decision flag value “1” from host computer 106. The caller's selection may, alternatively, be spoken into the caller's telephone and received by a voice recognition subsystem associated with, or contained within, voice server 120b.

Continuing the above example, let's say the caller in this instance presses “2” to exercise the voice email messaging option. In response, voice server 120b elicits information from the caller to compose a voice email by email server 134. After the caller communicates the message content, including any subject of the voice email, through the established connection to server 120b, the message content is fed to email server 134 in a predetermined format. The message content may contain multimedia (e.g., audio, video and/or text) information, depending on the capability of the originating telephone used by the caller, and the media supported by server 120b. Email server 134 addresses the voice email containing the received message content with the earlier received email address, which is alexandra@aol.com in this instance, thereby realizing a complete voice email. Server 134 then delivers the complete voice email to the destination party, e.g., through the Internet.

The foregoing merely illustrates the principles of the invention. It will thus be appreciated that those skilled in the art will be able to devise numerous other arrangements that embody the principles of the invention and are thus within the spirit and scope of the invention, which is defined by the claims below.

For example, information/call center 100 is disclosed herein in a form in which various functions are performed by discrete functional blocks. However, any one or more of these functions could equally well be embodied in an arrangement in which the functions of any one or more of those blocks or, indeed, all of the functions thereof are realized, for example, by one or more appropriately programmed processors.

What is claimed is:

1. A method for providing information assistance service, comprising:
receiving from a caller a call which includes an information assistance request;
searching a database for a destination telephone number associated with a destination party in response to the request;
establishing a connection connecting the call to a communication device associated with the destination telephone number;
monitoring for a condition of the connection;
when the condition is detected, automatically searching a second database for a record associated with the caller based on caller identifying information communicated to the service during the call;
searching the record for data concerning an email address associated with the destination party based on the destination telephone number; and
if the data is found, offering to send an email message to the email address.

2. The method of claim 1, further comprising eliciting from the caller content of the email message after the caller accepts the offer.

3. The method of claim 2, wherein the content comprises voice content, the method further comprising allowing the caller to provide the voice content via voice media.

4. The method of claim 1, wherein the caller identifying information includes an automatic number identification (ANI) associated with the call.

5. The method of claim 1, wherein the caller identifying information includes a voiceprint of the caller.

6. The method of claim 1, wherein the record is maintained by the service for the caller.

7. The method of claim 1, wherein the condition includes a busy condition.

8. The method of claim 1, wherein the condition includes a ring-no-answer condition.

9. The method of claim 1, wherein the condition includes a network communication problem.

10. A system for providing information assistance service, comprising:
an interface for receiving from a caller a call which includes an information assistance request;
a database, the database being searched for a destination telephone number associated with a destination party in response to the request;
a mechanism for establishing a connection connecting the call to a communication device associated with the destination telephone number;
a processor for monitoring for a condition of the connection;
a second database, when the condition is detected, the second database being searched for a record associated with the caller based on caller identifying information communicated to the service during the call, the record being searched for data concerning an email address associated with the destination party based on the destination telephone number; and
a server for offering to send an email message to the email address if the data is found.

11. The system of claim 10, wherein content of the email message is elicited from the caller after the caller accepts the offer.

12. The system of claim 11, wherein the content comprises voice content, the caller being allowed to provide the voice content via voice media.

13. The system of claim 10, wherein the caller identifying information includes an ANI associated with the call.

14. The system of claim 10, wherein the caller identifying information includes a voiceprint of the caller.

15. The system of claim 10, wherein the record is maintained by the service for the caller.

16. The system of claim 10, wherein the condition includes a busy condition.

17. The system of claim 10, wherein the condition includes a ring-no-answer condition.

18. The system of claim 10, wherein the condition includes a network communication problem.
